(19) United States
(12) Patent Application Publication
(10) Pub. No.: US 2026/0038466 A1
(43) Pub. Date: Feb. 5, 2026

(54) ADJUSTABLE DRUM MALLET

(71) Applicant: Tsun-Chi LIAO, Taichung City (TW)

(72) Inventor: Tsun-Chi LIAO, Taichung City (TW)

(21) Appl. No.: 18/794,126

(22) Filed: Aug. 5, 2024

(51) Int. Cl. G10D 13/11

(52) U.S. Cl. CPC G10D 13/11

(57) ABSTRACT

The present invention provides an adjustable drum mallet for a drum pedal, including a swinging element, an adjusting seat, a beater head, and a first locking element. The swinging element is fixed to the rotating base and includes a threaded rod. The adjusting seat includes a threaded through hole for the threaded rod spirally passing through, and a first tightening screw hole transversely penetrating the threaded through hole. The beater head is wrapped and fixed to the adjusting seat and exposes the threaded through hole and the first tightening screw hole, the first locking element is screwed into the first tightening screw hole and extended in the threaded through hole. Accordingly, the adjusting seat can be secured to the threaded rod by screwing the first locking element into the first tightening screw hole to compress the adjusting seat.

### FIELD OF THE INVENTION

The present invention relates to drum pedal, and in particular to drum mallet with adjustable striking positions.

### BACKGROUND OF THE INVENTION

As U.S. Pat. No. 6,822,149 B1 and U.S. Pat. No. 9,236,038 B1 respectively disclose a drum pedal for kicking a musical instrument such as a bass drum, the structure of which mainly consists of a drum mallet, a pedal, a bracket, and a reset element, wherein the drum mallet is mounted on a shaft, and the shaft is pivoted on the bracket. The pedal drives the shaft to rotate when the pedal is stepped on, and the drum mallet pivots around the bracket and moves from an initial position to a striking position to kick an instrument to make a sound when the instrument is placed on the kicking position. In addition, the reset element is installed between the bracket and the shaft. When the shaft rotates, the reset element drives the shaft back to an angle before the rotation and also drives the drum mallet back to the initial position from the striking position.

The drum mallet is used to strike the drum to make a thumping sound, which determines the rhythm of the music and is an essential part of the orchestra. The sound made by the drum mallet depends on the characteristics of the drum, the position of striking, and force of the drum mallet, and so on.

Conventional drum mallets have a fixed design with a fixed striking position. To meet the demand for the striking position of different sizes of drums, multiple drum mallets of different sizes and specifications need to be prepared for replacement, which will cause trouble in use.

In addition, different sizes of drum pedals have different pedals and brackets, which can also lead to changes in the striking position. When in actual use, it is also needed to replace drum mallets of different sizes to meet the demand for the striking position.

### SUMMARY OF THE INVENTION

The main object of the present invention is to disclose an adjustable drum mallet at a striking position to meet using requirements of changing striking positions.

In order to achieve the above-mentioned object, the present invention provides an adjustable drum mallet fixed to a rotating base of a drum pedal, comprising a swinging element, an adjusting seat, a beater head and a first locking element. The swinging element is in a shape of an elongated rod, and includes a first end and a second end opposite to each other. The first end is fixed to the rotating base, the second end includes a threaded rod, the adjusting seat includes a threaded through hole and a first tightening screw hole, wherein the threaded through hole is provided for the threaded rod spirally passing through, and the first tightening screw hole transversely penetrates the threaded through hole. The beater head is wrapped and fixed to the adjusting seat and exposes the threaded through hole and the first tightening screw hole. The first locking element is capable of screwing into the first tightening screw hole and extended in the threaded through hole.

Accordingly, the adjusting seat of the present invention can be screwed into the threaded rod to adjust a position of the beater head on the swinging element. When the beater head is adjusted to a desired position, the adjusting seat can be fixed on the threaded rod by screwing the first locking element into the first tightening screw hole to compress and fix the adjusting seat to the threaded rod. When using different sizes of pedal drums or different sizes of drums, the beater head can be adjusted to a desired striking position to meet the needs of use.

### BRIEF DESCRIPTION OF THE DRAWING

FIG. 1 is a combined structure diagram of the present invention.

FIG. 2 is an exploded diagram of the present invention.

FIG. 3 is a schematic diagram for installation and use of the present invention.

FIG. 4 is a schematic diagram of adjusting a drum mallet position of the present invention.

### DETAILED DESCRIPTION OF THE PREFERRED EMBODIMENTS

The technical contents of the present invention are described as follows with reference to the accompanying drawings.

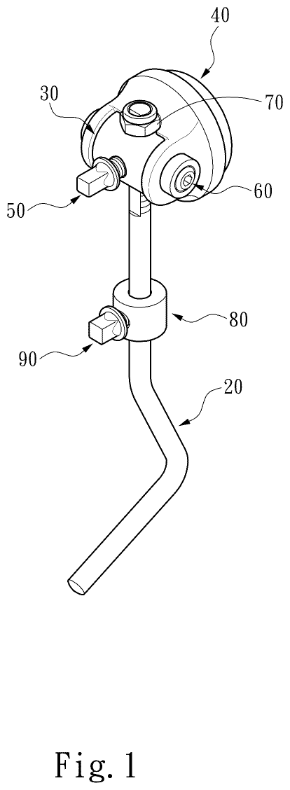

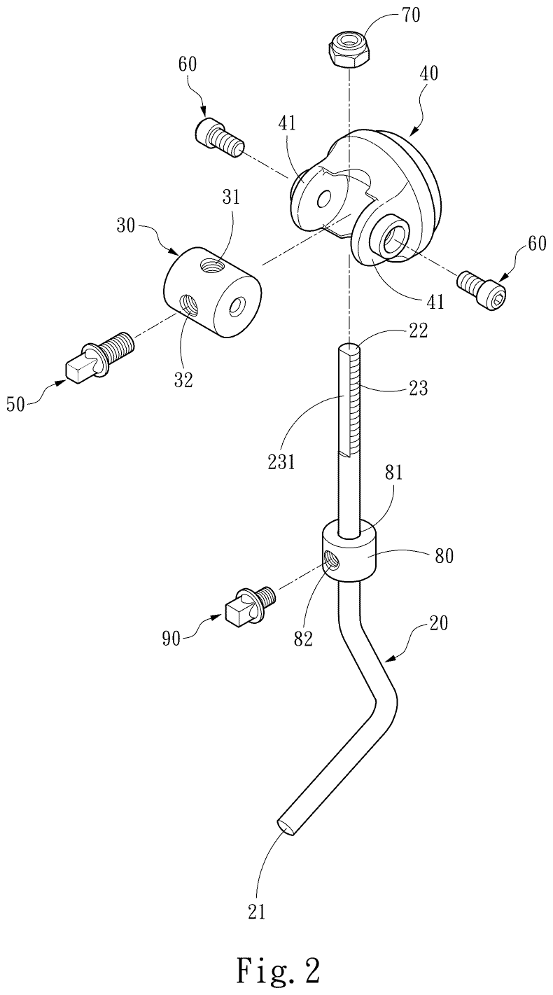

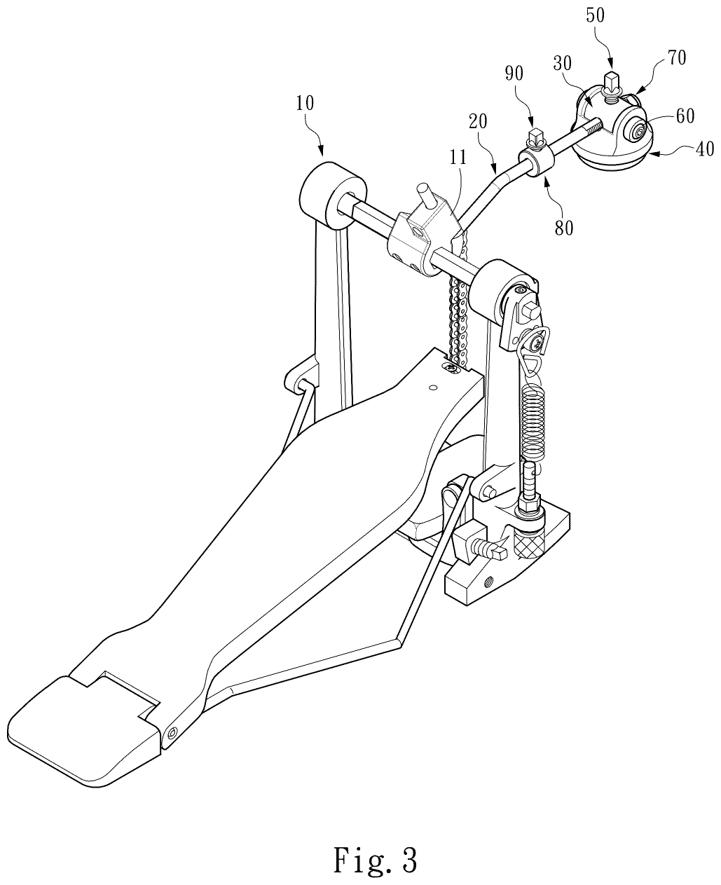

Please refer to FIG. 1, FIG. 2 and FIG. 3, the present invention provides an adjustable drum mallet fixed to a rotating base 11 of a drum pedal 10, the drum pedal 10 comprising a swinging element 20, an adjusting seat 30, a beater head 40 and a first locking element 50.

The swinging element 20 is in a shape of an elongated rod, and includes a first end 21 and a second end 22 opposite to each other. The first end 21 is fixed to the rotating base 11, the second end 22 includes a threaded rod 23, the adjusting seat 30 includes a threaded through hole 31 and a first tightening screw hole 32, wherein the threaded through hole 31 is provided for the threaded rod 23 spirally passing through, and the first tightening screw hole 32 transversely penetrates the threaded through hole 31.

The beater head 40 is wrapped and fixed to the adjusting seat 30 and exposes the threaded through hole 31 and the first tightening screw hole 32. In one embodiment, the adjusting seat 30 is cylindrical, the beater head 40 has two lugs 41 clamped the adjusting seat 30 from two sides, and two locking elements 60 are used to pass through the two lugs 41 and lock the adjusting seat 30 respectively.

The first locking element 50 is capable of screwing into the first tightening screw hole 32 and extended in the threaded through hole 31. In one embodiment, the threaded rod 23 includes a compression plane 231 for the first locking element 50 to press against, which ensures that the threaded rod 23 does not rotate when pressed against the first locking element 50. Preferably, the threaded rod 23 is screwed to a fixing nut 70 so that the fixing nut 70 presses the adjusting seat 30 and further strengthens the fixing of the adjusting seat 30.

In addition, the swinging element 20 is inserted into a counterweight element 80 adjacent to the threaded rod 23. The counterweight element 80 includes a through hole 81 and a second tightening screw hole 82, the through hole 81 is provided for the swinging element 20 to pass through, the second tightening screw hole 82 transversely penetrates the through hole 81 and is provided for a second locking element 90 to extended in the through hole 81 so that the counterweight element 80 is fixed to the swinging element 20.

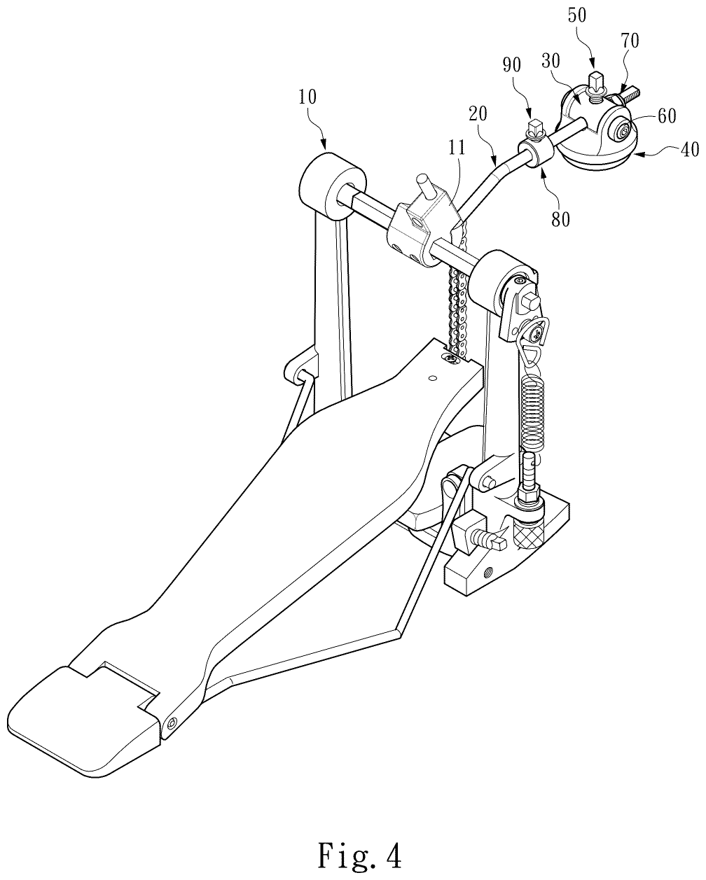

Please refer to FIG. 4, the adjusting seat 30 is screwed into the threaded rod 23 to adjust a position of the beater head 40 on the swinging element 20, when the beater head 40 is adjusted to a desired position (as shown in FIG. 4), the adjusting seat 30 can be secured to the threaded rod 23 by screwing the first locking element 50 into the first tightening screw hole 32 to compress the adjusting seat 30 to satisfy the demand for the use of the striking.

In summary, the adjusting seat of the present invention can be rotated on the threaded rod and adjusted to the desired position for the use of the striking after the first locking element is tightly fixed. The beater head can be adjusted to a desired striking position to meet the needs of use when using different sizes of pedal drums or different sizes of drums.

What is claimed is:

1. An adjustable drum mallet, fixed to a rotating base of a drum pedal, comprising:
a swinging element, in a shape of an elongated rod, comprising a first end and a second end opposite to each other, the first end fixed to the rotating base, and the second end comprising a threaded rod;
an adjusting seat, comprising a threaded through hole and a first tightening screw hole, the threaded through hole provided for the threaded rod spirally passing through, and the first tightening screw hole transversely penetrating the threaded through hole;
a beater head, wrapped and fixed to the adjusting seat and exposing the threaded through hole and the first tightening screw hole; and
a first locking element, screwed into the first tightening screw hole and extended in the threaded through hole.

2. The adjustable drum mallet according to claim 1, wherein the threaded rod comprises a compression plane for the first locking element to press against.

3. The adjustable drum mallet according to claim 1, wherein the threaded rod is screwed to a fixing nut for pressing the adjusting seat.

4. The adjustable drum mallet according to claim 1, wherein the swinging element is inserted into a counterweight element adjacent to the threaded rod, the counterweight element comprises a through hole and a second tightening screw hole, the through hole is provided for the swinging element to pass through, the second tightening screw hole transversely penetrates the through hole and is provided for a second locking element to extended in the through hole so that the counterweight element is fixed to the swinging element.

5. The adjustable drum mallet according to claim 1, wherein the adjusting seat is cylindrical, the beater head comprises two lugs clamped the adjusting seat from two sides, and two locking elements are provided for passing through the two lugs and locking the adjusting seat, respectively.
